(19) United States
(12) Patent Application Publication
(10) Pub. No.: US 2004/0014504 A1
(43) Pub. Date: Jan. 22, 2004

(54) Display device for mobile telecommunications apparatus

(76) Inventors: Nicholas Richard Coates, East Sussex (GB); Stanley John Tofield, West Sussex (GB)

Correspondence Address: Iandiorio & Teska, 260 Bear Hill Road, Waltham, MA, 02451-1018, US

(21) Appl. No.: 10/312,965

(22) PCT Filed: Jun. 29, 2001
(86) PCT No.: PCT/GB01/02888

(30) Foreign Application Priority Data
Jul. 3, 2000 (GB) 0016326.1

(51) Int. Cl. H04M 1/00

(52) U.S. Cl. 455/566; 455/550.1

(57) ABSTRACT

A display device (2) for mobile telecommunications apparatus, which display device comprises: i) a display panel (4); ii) pancake optical means (6) for producing: a) a collimated image to an eye (8) of a viewer so that the image is able to be seen normally from distances as close as it is physically possible to get the eye (8) of the viewer to the display panel (4); and b) an un-collimated image which is equivalent to viewing the display panel (4) directly; iii) polarising filter means (10) for suppressing the un-collimated image; and iv) rotator means (14) for rotating at least part of the filter means (10) through 90° in order to allow the un-collimated image to be used, whereby the display device (2) is such that the user can select an un-collimated viewing mode if the image is of a simple content, and a viewer can select a collimated viewing mode if the image is of a detailed content.

This invention relates to a display device and, more especially, this invention relates to a display device for mobile telecommunications apparatus such for example as mobile telephones and pagers.

Mobile telecommunications apparatus such for example as mobile telephones and pagers has the ability to transmit and receive images. In order to display an image, the mobile telecommunications apparatus has to be fitted with a display panel. The mobile telecommunications apparatus is constructed to be as small as possible for convenience of carrying, and this means that the display panel must be small. A small display panel in turn means that it is difficult or often impossible to view any image other than an image of simple content such for example as an image of just a few words. If the image is of a detailed content such for example as a page of text or a high definition picture, then it is often difficult or impossible to see such an image. An image with a detailed content could be viewed via a magnifying eyepiece, but then simple messages could not be seen without holding the eye piece, up to an eye of a viewer. Also, with such a construction, the mobile telecommunications apparatus would have to look different in appearance and it would have to be used differently. This may not be commercially acceptable in many situations where, for example, mobile telephones are of a generally standard shape which has been accepted by users.

It is an aim of the present invention to obviate or reduce the above mentioned problem.

Accordingly, in one non-limiting embodiment of the present invention there is provided a display device for mobile telecommunications apparatus, which display device comprises:

(i) a display panel,

(ii) pancake optical means for producing (a) a collimated image to an eye of a viewer so that the image is able to be seen normally from distances as close as it is physically possible to get the eye of the viewer to the display panel, and (b) an un-collimated image which is equivalent to viewing the display panel directly,

(iii) polarising filter means for suppressing the un-collimated image, and

(iv) rotator means for rotating at least part of the filter means through 90° in order to allow the un-collimated image to be used, whereby the display device is such that the user can select an un-collimated viewing mode if the image is of a simple content, and a viewer can select a collimated viewing mode if the image is of a detailed content.

As indicated above, the mobile telecommunications apparatus will usually be a mobile telephone or a pager. Other mobile telecommunications apparatus may however be provided with the display device of the present invention. Where the image is of a simple content, then the image may be of a few words and/or a simple picture. Such an image of simple content can be viewed directly at arm's length or at any other suitable position remote from the viewer's eye. Where the image is of a detailed content, then the image may be a long text and/or a complicated picture.

The display device may be one in which the rotator means is a mechanical rotator means. Alternatively, the display device may be one in which the rotator means is a liquid crystal rotator means.

Preferably, the pancake optical means is a doublet lens comprising a plano-convex lens and a plano-concave lens.

The plano-convex and the plano-concave lens may have a mating surface which is rendered semi-reflective. Preferably, the mating surface is rendered semi-reflective by a coating. Any suitable and appropriate coating material may be employed. Other means may be employed for rendering the mating surface semi-reflective.

In an alternative embodiment of the invention, the pancake optical means may have a flat image surface and it may comprise just a plano-convex lens or a plano-concave lens.

The display panel may be positioned behind the pancake optical means. The display panel provides an image source which is preferably of a type which emits polarised light.

With an image source of the type which emits polarised light, then the display device may be one in which the polarising filter means comprises a first quarterwave plate positioned in front of the display panel and orientated with its fast axis at 45° to the axis of polarisation of light from the display panel thereby to circularly polarise the light, and in which a second quarterwave plate is adhered to the output side of the pancake optical means with its fast axis at 90° to the first quarterwave plate thereby to return the light to plain polarisation.

With a mechanical rotator means, then the rotator means may be a mirror made of a polarising transflective film adhered to a flat disc. The flat disc may be made of glass or a suitable plastics material. The plastics material used must be non-birefringement such for example as cell cast acrylic.

The present invention also extends to mobile telecommunications apparatus when provided with the display device. The mobile telecommunications apparatus may be a mobile telephone, a pager or any other suitable and appropriate type of mobile telecommunications apparatus.

An embodiment of the invention will now be described solely by way of example and with reference to the accompanying drawings in which:

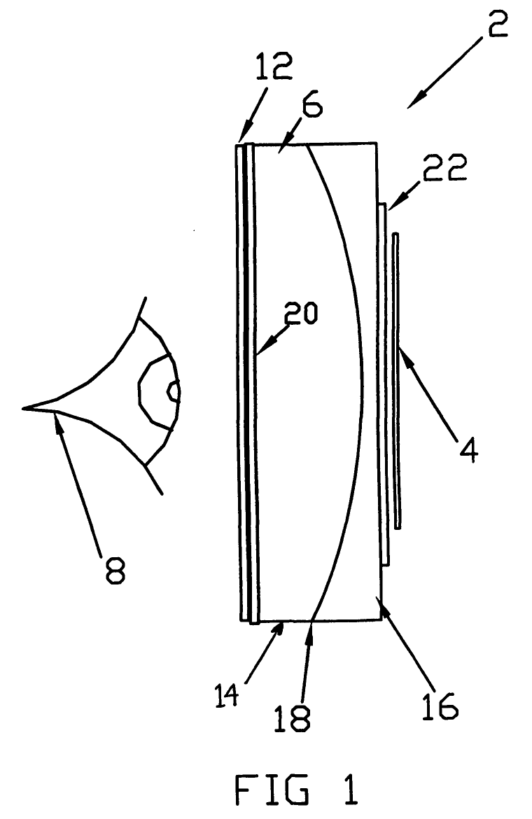

FIG. 1 shows a display device for mobile telecommunications apparatus in the form of a mobile telephone; and

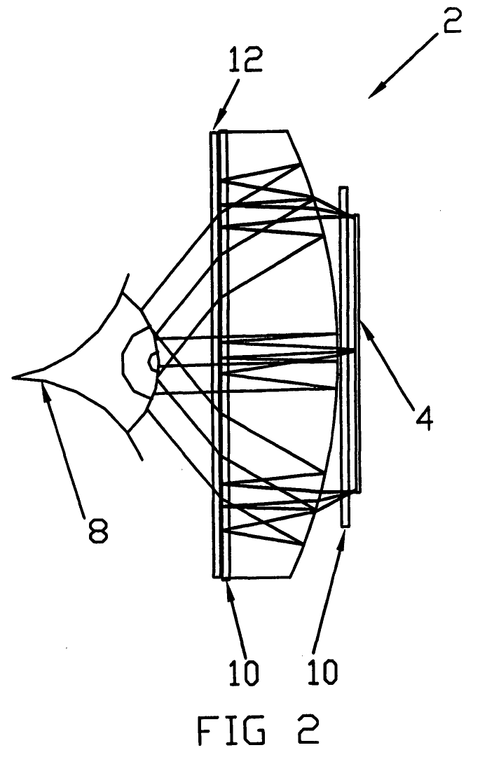

FIG. 2 illustrates by way of light ray paths the operation of the display device shown in FIG. 1.

Referring to the drawings, there is shown a display device 2 for a mobile telephone. The display device 2 comprises a display panel 4. The display device 2 also comprises pancake optical means 6 for producing (a) a collimated image to an eye 8 of a viewer so that the image is able to be seen normally from distances as close as it is physically possible to get the eye 8 of the viewer to the display panel 4, and (b) an un-collimated image which is equivalent to viewing the display panel 4 directly, for example at arm's length.

The display device 2 further comprises polarising filter means 10 and rotator means 12. The rotator means 12 is for rotating at least a part of the polarising filter means 10 through 90° in order to allow the un-collimated image to be viewed, whereby the display device is such that the user can select an un-collimated viewing mode if the image is of a simple content, and the user can select a collimated viewing mode if the image is of a detailed content.

The rotator means 12 is in the form of a rotatable front disc having a polarising transflective film mirror.

The pancake optical means 6 is a doublet lens comprising a plano-convex lens 14 and a plano-concave lens 16. The plano-convex lens 14 and the plano-concave lens 16 have a mating surface 18 which is rendered semi-reflective by a coating.

The polarising filter means 10 comprises a first quarterwave plate 20 positioned in front of the image source and orientated with its fast axis at 450 to the axis of polarisation of light from the image source thereby to circularly polarise the light. The polarising filter means 10 also comprises a second quarterwave plate 22 which is adhered to the output side of the combined plano-convex lens 14 and the plano-concave lens 16, with the fast axis of the second quarterwave plate 22 being at 90° to the first quarterwave plate 20, thereby to return the light to plain polarisation.

The mode of operation of the display device 2 can be seen from the light rays shown in FIG. 2. More specifically, the rotator means 12 as mentioned above comprises a mirror made from polarising transflective film cemented to a flat glass or a plastics disc. The polarising transflective film is a plastics film which reflects polarised light of one orientation, while transmitting linearly polarised light of the orthogonal orientation. The disc can be rotated through 90°. With the transmission axis of the polarising transflective film aligned with the axis of the emerging light, the un-collimated image can be viewed. With the transmission axis of the film at 900 to the emerging light, the light will be reflected back into the system. When this light hits the curved mating surface 18, some of the light is reflected forwards again, the curved surface having the effect of collimating the image. This light returns to the transflective film having made two passes through the quarterwave plate. This has the effect of rotating the axis of polarisation so that it is now parallel to the transmission axis of the polarising transflective film. The collimated image thus exits the display device 2 and can be viewed on the display panel 4.

It is to be appreciated that the embodiment of the invention described above with reference to the accompanying drawings has been given by way of example only and that modifications may be effected. Thus, for example, instead of a mechanical rotator means 12, the rotation could be done electronically with a liquid crystal device. Also, if a flat image surface is used, then half of the doublet comprising the plano-convex lens 14 and the plano-concave lens 16 may be dispensed with.

1. A display device for mobile telecommunications apparatus, which display device comprises:
(i) a display panel,
(ii) pancake optical means for producing (a) a collimated image to an eye of a viewer so that the image is able to be seen normally from distances as close as it is physically possible to get the eye of the viewer to the display panel, and (b) an un-collimated image which is equivalent to viewing the display panel directly,
(iii) polarising filter means for suppressing the un-collimated image, and
(iv) rotator means for rotating at least part of the filter means through 90° in order to allow the un-collimated image to be used, whereby the display device is such that the user can select an un-collimated viewing mode if the image is of a simple content, and a viewer can select a collimated viewing mode if the image is of a detailed content.

2. A display device according to claim 1 in which the rotator means is a mechanical rotator means.

3. A display device according to claim 1 in which the rotator means is a liquid crystal rotator means.

4. A display device according to any one of the preceding claims in which the pancake optical means is a doublet lens comprising a plano-convex lens and a plano-concave lens.

5. A display device according to claim 4 in which the plano-convex lens and the plano-concave lens have a mating surface which is rendered semi-reflective.

6. A display device according to claim 5 in which the mating surface is rendered semi-reflective by a coating.

7. A display device according to any one of claims 1-3 in which the pancake optical means has a flat image surface and comprises a plano-convex lens or a plano-concave lens.

8. A display device according to any one of claims 4-7 in which the display panel is positioned behind the pancake optical means.

9. A display device according to claim 8 in which the display panel provides an image source which is of a type which emits polarised light.

10. A display device according to claim 9 in which the polarising filter means comprises a first quarterwave plate positioned in front of the display panel and orientated with its fast axis at 45° to the axis of polarisation of light from the display panel thereby to circularly polarise the light, and in which a second quarterwave plate is adhered to the output side of the pancake optical means with its fast axis at 90° to the first quarterwave plate thereby to return the light to plain polarisation.

11. A display device according to claims 2 and 10 in which the rotator means is a mirror made from polarising transflective film adhered to a flat disc.

12. A display device according to claim 11 in which the flat disc is made of glass or a plastics material.

13. Mobile telecommunications apparatus when including the display device according to any one of the preceding claims.

14. Mobile telecommunications apparatus according to claim 13 in which the mobile telecommunications apparatus is a mobile telephone or a pager.
